(19) United States
(12) Patent Application Publication
(10) Pub. No.: US 2016/0162036 A1
(43) Pub. Date: Jun. 9, 2016

(54) SYSTEM AND ACCOMPANYING METHOD FOR INTERACTING WITH A CARD ON AN INTERACTIVE SURFACE

(71) Applicants: Zheng Shi, Beijing (CN); Richard-Martin Dickinson, Beijing (CN)

(72) Inventors: Zheng Shi, Beijing (CN); Richard-Martin Dickinson, Beijing (CN)

(21) Appl. No.: 14/819,456

(22) Filed: Aug. 6, 2015

Related U.S. Application Data
(63) Continuation-in-part of application No. PCT/CN2015/079606, filed on May 22, 2015.
Application No. PCT/CN2015/079606 is a continuation-in-part of application No. PCT/CN2014/090890, filed on Nov. 12, 2014.

(51) Int. Cl. G06F 3/01; G06F 3/041; G06F 3/044

(52) U.S. Cl. CPC G06F 3/017; G06F 3/044; G06F 3/0416

(57) ABSTRACT

The present invention discloses a system and accompanying method for interacting with a card marked with a user interface element on an interactive surface wherein, upon a capacitive action being performed on the card placed upon the interactive surface, a processor is configured to detect a change in capacitive coupling, and recognizes that a first parameter of a user interface element has been specified by a user.

### CROSS-REFERENCE TO RELATED APPLICATION

This application is a continuation in part of International Patent Application No. PCT/CN2015/079606, entitled “A System and Accompanying Method for Interacting with a Card on an interactive Surface”, filed on May 22, 2015, which is a continuation in part of International Patent Application No. PCT/CN2014/090890, entitled “System and Method for Recognizing Objects with Continuous Capacitance Sensing”, filed on Nov. 12, 2014.

The entire disclosures of each of the above applications are incorporated herein by reference.

### TECHNICAL FIELD

The present invention relates to an interactive surface, and more particularly, the interaction between a card marked with a user interface element and the interactive surface.

### BACKGROUND

Computer systems use a combination of screens and input devices such as keyboards and mouse devices in order for a user to operate computer programs. The GUI (Graphical User Interface) that uses the WIMP (window, icon, menu and pointing device) principle was invented at the Xerox Park Lab in the 1970s. This was to become the template by which all commercial computer systems would adhere to. Indeed, all commercial systems developed by Apple, Microsoft and Sun Microsystems to this day use some form of GUI system in order to allow users to naturally interact with computer programs.

However, depending on the application, it is at times desirable to allow for the interaction with a computer program to be made through the use of physical objects. This is particularly true for young children who have a natural affinity for physically manipulating objects. This also holds true whenever an open platform for group discussion and group play is used as the manipulation of physical Objects naturally accommodates the interaction of several people using the same computer program. There is a clear contrast between the user experience derived from using physical objects and that of using the traditional screen-based method; a screen serves as a window of information whereas physical manipulation is a medium for personal use.

In order to enhance the experience of operating a computer program through physical object manipulation, there is a need to enable the “state” of a user interface element represented by a physical object to be managed. That is to say, the “state” should be visually presented to an end-user, and the “state” needs to change in response to the action by an end-user and according to logic of the computer program.

The use of physical objects placed on the surface of smart screens or electronic pads are known. A popular example of such would be Mattel's Apptivity toy series whereby players interact with a video game by moving a toy figurine across an iPad surface. Although this product is visually impressive, actual interaction between the object and the software is limited to tracking the location and orientation of the object relative to the surface of the iPad. Thus, enhanced interactions between the player and the object such as allowing for touch-sensitivity of the object itself would therefore allow a whole new interactive dimension between the user and the software.

### SUMMARY OF INVENTION

The present invention discloses a system and accompanying method for interacting with a card marked with a user interface element on an interactive surface wherein, upon a capacitive action being performed on the card placed upon the interactive surface, a processor is configured to detect a change in the capacitive coupling, and recognizes that a first parameter of a user interface element has been specified by a user.

A capacitance sensor embedded in the interactive surface recognizes a card and a further finger touch upon the card through sensing a change in capacitance caused by the presence of the card, or the card plus the finger touch. In one embodiment of the present invention, the change in capacitance detected by the capacitance sensor is a change of magnitude of the self capacitance formed between the card, or the card plus the finger, and the sensing capacitive electrode. In another embodiment of the present invention, a capacitance sensor electrode is connected to a LC oscillator with a starting frequency, and the change in capacitance detected by the capacitance sensor is a shift of oscillation frequency due to the self capacitance formed between the card, or the card plus the finger, and the sensing capacitive electrode.

The system of the present invention comprising: a card visually marked with a user interface element; an interactive surface; a processor operatively linked to the interactive surface that is configured to detect capacitive coupling between the card and the interactive surface whenever the card is placed upon the interactive surface, and further configured to detect capacitive coupling from a capacitive action acted upon the card.

Optionally, the system and method further comprising a computer program that utilizes the user interface element, wherein the processor is configured to provide the computer program with the first parameter of the user interface element.

Optionally, the interactive surface is embedded with an electrode array configured to detect capacitive coupling between the interactive surface and a card placed on the interactive surface.

Optionally, the card comprises capacitive material.

Optionally, the processor is configured to identify the unique ID of the card once placed upon the interactive surface.

Optionally, the capacitive action being performed on the user interface element consists of a finger gesture acted upon the card.

Optionally, the finger gesture is selected from a group consisting of a short finger touch, a long finger touch, multiple simultaneous finger touches, repetitive touches, sliding of the finger across the surface of the card and a pinch gesture performed by two or more fingers.

Optionally, upon a second finger gesture being performed on the user interface element, the processor is configured to recognize that a second parameter of the user interface element has been specified by a user.

Optionally, the capacitive action being performed on the user interface element consists of placing a second card upon or next to the first card.

### BRIEF DESCRIPTION OF THE DRAWINGS

To better illustrate the technical features of the embodiments of the present invention, various embodiments of the present invention will be briefly described in conjunction with the accompanying drawings. It should be obvious that the drawings are but for exemplary embodiments of the present invention, and that a person of ordinary skill in the art may derive additional drawings without deviating from the principles of the present invention.

FIG. 1 is an exemplary schematic diagram illustrating the system process flow in accordance with one embodiment of the present invention.

FIG. 2 is an exemplary schematic diagram of the system of the interactive surface whereby each layer of the interactive surface has been separated for illustration sake in accordance to one embodiment of the present invention.

FIGS. 3a and 3b are exemplary schematic diagrams further illustrating the process of detection of a touch action by the interactive surface in accordance to one embodiment of the present invention.

FIGS. 4a and 4b illustrate a card placed upon an interactive surface in accordance to one embodiment of the invention.

FIG. 5 illustrates an interactive card placed upon the interactive surface in order to play a music compilation in accordance to one embodiment of the invention.

### DETAILED DESCRIPTION OF THE INVENTION

Reference will now be made in detail to various embodiments of the invention. While the invention will be described in conjunction with the embodiments, it will be understood that this is not intended to limit the scope of the invention to these specific embodiments. The invention is intended to cover all alternatives, modifications and equivalents within the spirit and scope of invention, which is defined by the apprehended claims.

Furthermore, in the detailed description of the present invention, specific details are set forth in order to provide a thorough understanding of the present invention. However, it will be obvious to one of ordinary skill in the art that the present invention may be practiced without these specific details. In other instances, well known methods, procedures, components, and circuits are not described in details to avoid unnecessarily obscuring a clear understanding of the present invention.

The present invention may be better understood and its numerous objectives and advantages will become apparent to those skilled in the art by reference to the accompanying drawings.

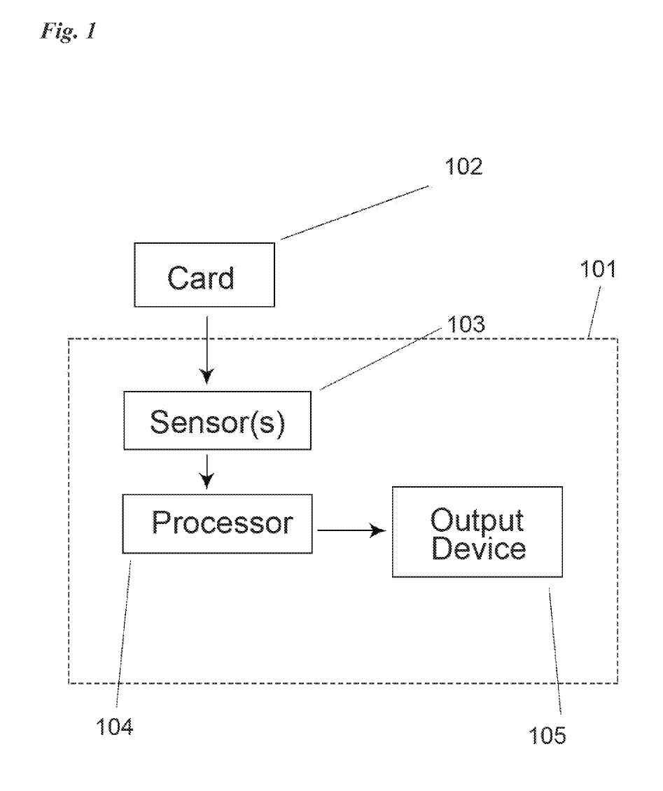

FIG. 1 is an exemplary schematic diagram illustrating the system process flow in accordance with one embodiment of the present invention. As shown in FIG. 1, the system includes one or more cards 102, each having a unique identification code (UID) and visually marked with a User Interface (UI) element of a computer program. The UID can be encoded with a radio frequency identification chip (RFID), a pattern of capacitance tabs, or a pattern of magnetic tabs. The system further includes an interactive surface 101 embedded with a sensor system 103 and a processor 104 that are configured to detect the UID of a card 102 and to derive the location of the card 102 once placed upon the interactive surface 101. The processor 104 is operatively linked to the interactive surface 101 and is configured to execute a computer program and direct the various electronic components of the interactive surface 101. The interactive surface 101 may further include one or more output devices 105 that are operatively controlled by the processor 104.

During runtime execution of the computer program, and in response to a capacitive action such as a touch action by a user upon a card 102, the sensor system 103 and the processor 104 of the interactive surface 102 are configured to detect the touch action and thereupon the processor 104 is configured to recognize that a first parameter of the user interface element of a computer program has been specified by a user. The touch action can consist of but is not limited to a short finger touch, a long finger touch, multiple simultaneous finger touches, repetitive tapping, sliding of the finger across the surface of the card and a pinch gesture performed by two or more fingers. A short finger touch is defined as a finger touch lasting less than half of a second whereas a long finger touch consists of a finger touch lasting longer than half of a second.

The processor 104 may further direct one or more output devices 105 to indicate a new state of the UI element marked on the card 102. The output device 105 can consist of but is not limited to be an LED light, an audio device, a video device, or a vibration generator device, and could provide users with feedback in the form of audio or visual effects. The feedback device 105 can be embedded within the interactive surface or within the card 102 itself.

A capacitance sensor of the sensor system 103 embedded in the interactive surface 101 recognizes the card 102 and a further finger touch upon the card 102 through sensing a change in capacitance caused by the presence of the card 102, or the card 102 plus the finger touch. The change in capacitance detected by the capacitance sensor could be a change of magnitude of the self capacitance formed between the card 102, or the card 102 plus the finger, and the sensing capacitive electrode. The capacitance sensor electrode could also be connected to a LC oscillator with a starting frequency, and thus the change in capacitance detected by the capacitance sensor is a shift of oscillation frequency due to the self capacitance formed between the card 102, or the card 102 plus the finger, and the sensing capacitive electrode.

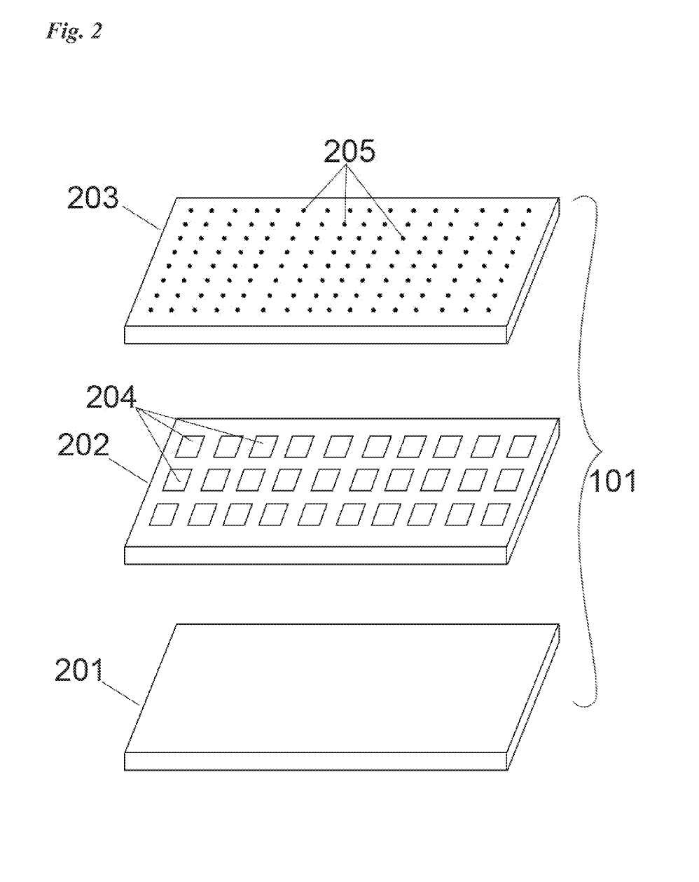

FIG. 2 is an exemplary schematic diagram of the system of the interactive surface 101 whereby each layer of the interactive surface 101 has been separated for illustration sake in accordance to one embodiment of the present invention. In the embodiment of FIG. 2, the interactive surface 101 has three layers. The bottom layer 201 is the substrate or base of the interactive surface 101. On top of the bottom layer is the second layer 202 which consists of an array of RF antennas 204 that is configured to wirelessly communicate with the RFID tags of the cards placed upon the interactive surface 101 so as to determine the UID of the cards. On top of the second layer 202 is the third layer 203 which comprises of an array of electrodes 205 whose function is to detect, through capacitive coupling with the card, the location and orientation of cards placed upon the interactive surface 101 and transmit that information to the processor 104. Cards can be designed in a number of ways in order to ensure capacitive coupling between the interactive surface's 101 array of electrodes and the card. In one embodiment the card is coated or made with conductive material such as ITO (Indium Tin Oxide). In another embodiment, the card is embedded with a pattern of one or more capacitive tabs.

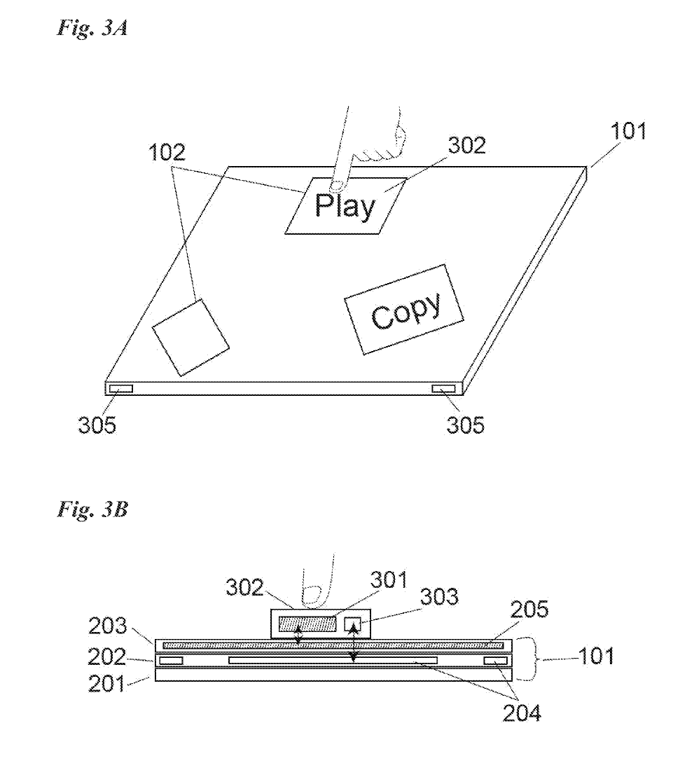

FIGS. 3a and 3b are exemplary schematic diagrams further illustrating the process of detection of a touch action by the interactive surface 101 in accordance to one embodiment of the present invention. A plurality of cards 102, each visually marked with a UI element of a computer program, are placed on the interactive surface 101. The UI element in this particular embodiment can be but is not limited to: start, stop, save, delete, okay, cancel, play, replay, record, complete, copy, duplicate, export, import, a letter of an alphabet, a word of a language, an icon representing a musical symbol, or an icon representing a computer programming language symbol, etc. Each of the cards 102 further has an identifier that contains the UID information of the cards 102. The interactive surface 101 further includes an array of electrodes 205 and an RF antenna array 204 that are capable of detecting the UID and location the cards 102 placed upon it.

The cards 102 are embedded with a capacitance tab 301 so as to allow for capacitive coupling between the card 102 and the interactive surface's 101 electrodes 205 located under the card 102. The design of these capacitive tabs 301 is made so as to allow for further capacitive coupling between a user finger touch 302 on the card 102 and the interactive surface's 101 electrodes 205. Each card 102 is also embedded with an RFID chip 303 so as to allow for the interactive surface's 101 processor to read the UID of the card 102 through wireless communication between the card's 102 RFID chip 303 and the RF antenna of the RF antenna array 204 that is located closest to the card 102.

The processor may further direct one or more output devices to indicate a new state of the UI element marked on the card 102. The output device could be an LED light, an audio device, a video device, or a vibration generator device, and could provide users with physical feedback in the form of audio or visual effects. The output device can be embedded within the interactive surface or within the card itself. In FIGS. 3a and 3b, the sensory accessory consist of a speaker system 305 embedded in the interactive surface 101.

The method of the present invention in accordance to one embodiment of the present invention can be described as flows. As each card 102 is embedded with one or more capacitive tabs 301 so that, after the card 102 is placed upon the interactive surface 101 and a first change in capacitance has been detected by the electrodes 205 of the interactive surface 101, a further change in capacitance is detected and measured by the electrodes 205 whenever a human finger 302 touches the card 102. A signal representing this change in capacitance is sent to and recorded by the processor 104 and determined to be caused by a touch action, which enables the computer program to interpret the touch action into a change of the current state of the UI element marked on the card 102. An instruction is then provided to the processor according to the computer program regarding changing the current state of the UI element marked on the card 102 acted upon by the touch action. The processor 104 can then direct the speaker system 305 to broadcast an audio recording in order to indicate the new state of the UI element marked on the card 102 acted upon by the touch action. For example, an audio recording is broadcasted out once the card “PLAY” is touched by the finger of a user. Besides touching a card 102 once, the touch action 302 could also include touching a card 102 twice or more in rapid succession, touching the card 102 once but fur a longer duration of time (i.e. longer than half a second), multiple simultaneous finger presses, sliding of the finger across the surface of the card and a pinch gesture performed by two or more fingers.

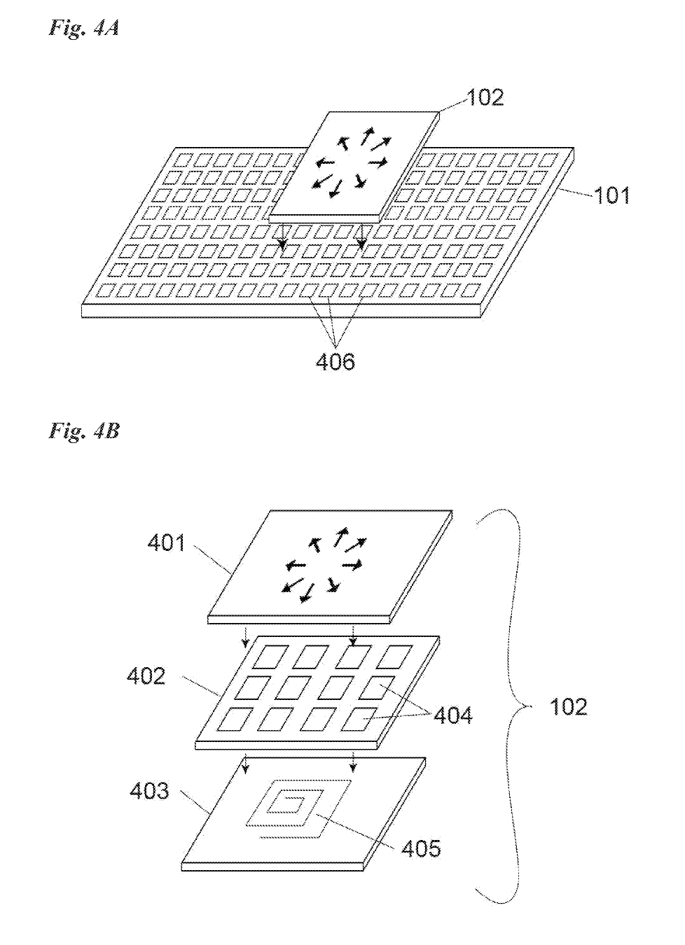

FIGS. 4a and 4b illustrate a card placed upon interactive surface 101 in accordance to one embodiment of the invention. Referring to FIGS. 4a and 4b, eight arrows pointing out in various directions from a single center point has been imprinted on the card's 102 surface. FIG. 4b further illustrates the layers that constitute the card 102. The top layer 401 comprises of the eight arrows imprinted upon the card 102 and the mid layer 402 comprises of a layer with a specific pattern of eight capacitance tabs 404 with each of these eight capacitance tabs 404 corresponding to one of the eight arrows of the top layer 401. Finally, the bottom layer 403 has an RFID chip 405 embedded in its center.

Whenever the card 102 is placed upon the interactive surface 102, the eight capacitance tabs 404 couple with the capacitance points 406 of the interactive surface 101 located under the card 102. The interactive surface's processor detects the coupling between some of the array's capacitive points 406 and the card's 102 and wirelessly communicates with the card's 102 RFID chip 405 in order to identify the UID of the card 102. Once the UID of the card 102 is determined, the processor proceeds to load the interface control program that corresponds to that particular card. Once the above steps are completed, a user can then proceed to interact with the card 102 using finger touches upon the surface of the card 102. Whenever a user presses once on one of the direction arrows imprinted on the card 102, the processor 104 wirelessly directs a remote controlled car to move according to the direction specified by the user. In this particular embodiment, one short press in a particular direction upon the card directs the remote controlled car to move for a defined amount of time in that direction.

The user can press multiple times upon a direction arrow of the card in order to cumulatively increase the amount the remote controlled car moves in that direction. They can, alternatively, keep their finger pressed on the direction arrow in order to yield the same command.

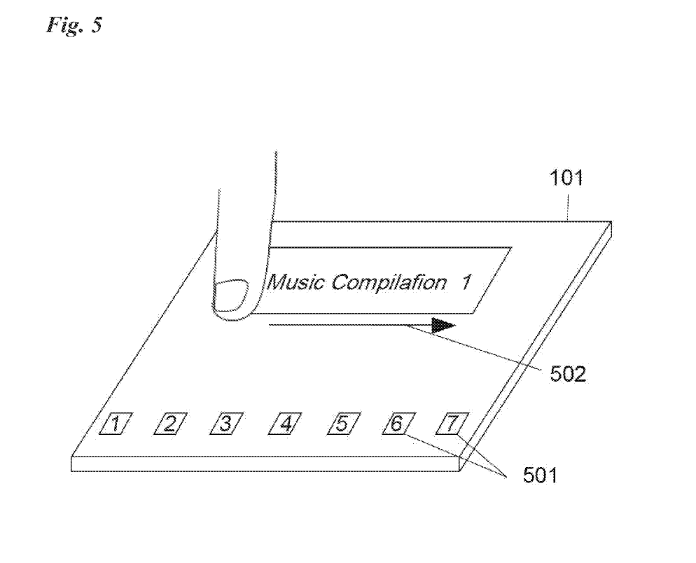

FIG. 5 illustrates an interactive card placed upon the interactive surface in order to play a music compilation in accordance to one embodiment of the invention. In this embodiment each card corresponds to a particular music compilation comprising a series of songs. A card is imprinted with a series of numbered boxes 501 where each number corresponds to a song in the card's music compilation. Whenever a user wants to activate the playing of a song, they place the music card upon the interactive surface 101, allowing for ID recognition of the music card and coupling between the card and the interactive surface 101. The user can then proceed to press on any of the numbers imprinted upon the music card which causes the processor to command an audio system to start playing the corresponding song. A user may further interact with the music card through various other finger gestures. In order to pause or play a song, the user can press their finger once in the center of the music card, causing it to play or pause the song depending on the state of the song playing at that time.

A user can rapidly switch to the next song of the compilation by sliding their finger from left to right along the music card as shown in FIG. 5 through the use of a finger sliding action 502.

1. A system for configuring a card on an interactive surface, comprising:
a card, embedded with an RFID chip containing unique ID information of the card and visually marked with one or more user interface elements;
an interactive surface;
a processor operatively linked to the interactive surface that is configured to identify the unique ID of the card and detect capacitive coupling between the card and the interactive surface whenever the card is placed upon the interactive surface, and further configured to detect a finger gesture performed upon the card while the card remains stationary;
wherein, upon the finger gesture being performed on the user interface element of the card, the interactive surface is configured to detect a change in capacitance, and the processor is configured to recognize that a first parameter of the user interface element has been specified by a user.

2. The system of claim 1, further comprising a computer program that utilizes the user interface element, wherein the processor is configured to provide the computer program with the first parameter of the user interface element.

3. The system of claim 1, wherein the interactive surface is embedded with an electrode array configured to detect capacitive coupling between the interactive surface and the card placed on the interactive surface.

4. The system of claim 1, wherein the card comprises of capacitive material.

5. (canceled)

6. (canceled)

7. The system of claim 1, wherein the finger gesture is selected from a group consisting of a short finger touch, a long finger touch, multiple simultaneous finger touches, repetitive touches, sliding of the finger across the surface of the card and a pinch gesture performed by two or more fingers.

8. The system of claim 1, wherein, upon a second finger gesture being performed on the user interface element, the processor is configured to recognize that a second parameter of the user interface element has been specified by a user.

9. The system of claim 1, wherein the capacitive action being performed on the user interface element consists of placing a second card upon or next to the first card.

10. A method for configuring a card on an interactive board, comprising:
placing a card embedded with an RFID chip containing unique ID information of the card and visually marked with one or more user interface elements upon the interactive surface;
identifying the unique ID of the card and detecting capacitive coupling between the card and the interactive surface by a processor;
performing a finger gesture by a user upon the card while the card remains stationary;
detecting a change in capacitance caused by the finger gesture performed on the user interface element of the card by the processor;
recognizing, by the processor, that a first parameter of the user interface element has been specified by the user.

11. The method of claim 10, further comprising a computer program that utilizes the user interface element, wherein the processor is configured to provide the computer program with the first parameter of the user interface element.

12. The method of claim 10, wherein the interactive surface is embedded with an electrode array configured to detect capacitive coupling between the interactive surface and the card placed on the interactive surface.

13. The method of claim 10, wherein the card comprises of capacitive material.

14. (canceled)

15. (canceled)

16. The method of claim 10, wherein the finger gesture is selected from a group consisting of a short finger touch, a long finger touch, multiple simultaneous finger touches, repetitive touches, sliding of the finger across the surface of the card and a pinch gesture performed by two or more fingers.

17. The method of claim 10, wherein, upon a second finger gesture being performed on the user interface element, the processor is configured to recognize that a second parameter of the user interface element has been specified by a user.

18. The method of claim 10, wherein the capacitive action being performed on the user interface element consists of placing a second card upon or next to the first card.
